(19) United States
(12) Patent Application Publication
(10) Pub. No.: US 2025/0289598 A1
(43) Pub. Date: Sep. 18, 2025

(54) Methods and Systems for Drone Deployment and Delivery Logistics

(71) Applicant: VALQARI HOLDINGS, LLC, Lombard, IL (US)

(72) Inventors: Charles Calvin Byers, Wheaton, IL (US); Geoffrey Forrest Graves, Bangkok (TH); Sean McShane, Naperville, IL (US)

(21) Appl. No.: 19/225,038

(22) Filed: Jun. 2, 2025

Related U.S. Application Data
(63) Continuation of application No. PCT/US23/82129, filed on Dec. 1, 2023.
(60) Provisional application No. 63/385,853, filed on Dec. 2, 2022.

(51) Int. Cl. B64U 70/92; B64U 80/25; B64U 101/64

(52) U.S. Cl. CPC B64U 70/92; B64U 80/25; B64U 2101/64

(57) ABSTRACT

Drone roosts, storage facilities, and/or drone delivery mailbox systems can be used to aid in drone deliveries and/or drone deployment. A roost can include a top hatch, a conveyor belt, a drone storage wheel with at least one drone storage shelf, and a conveyor door. In some embodiments a roost can include a plurality of trays configured to move along at least one guiderail and store drones. A storage facility can include an outer shell, a top aperture, a cargo delivery hatch, a gantry robot, a conveyor belt, an overhead camera, and/or a backstop. In some embodiments, the storage facility can include a landing tower, a package elevator, a cargo delivery door, and/or a package shuttle. In some embodiments, the storage facility is a circular drone delivery station. In some embodiments, a drone delivery mailbox system can a conveyor belt, a pair of bumpers, and/or a docking clamp.

### CROSS-REFERENCE TO RELATED APPLICATIONS

This application is a continuation of International Application No. PCT/US23/82129 having an international filing date of Dec. 1, 2023, entitled “Methods and Systems for Drone Deployment and Delivery Logistics”. The '129 application is related to and claims priority benefits from U.S. provisional application No. 63/385,853 filed on Dec. 2, 2022, also entitled “Methods and Systems for Drone Deployment and Delivery Logistics”. The present application also claims priority benefits from the '853 application.

The '129 and '853 applications are each hereby incorporated by reference herein in their entireties.

### FIELD OF THE INVENTION

The present invention relates to drone deliveries and drone deployment in general. In particular, the present invention relates to drone roosts and methods of employing them. The present invention is also related to package storage and retrieval facilities and methods of employing them. The present invention also relates to drone landing stations and methods of using them.

Online or remote shopping has grown immensely over the past decade. Remote shopping offers many benefits including: allowing customers to shop from literally anywhere in the world; eliminating the costs associated with having to ship, store, and sell items from traditional retail store locations; and enabling manufacturers and distributors to reach a larger market.

However, despite these advantages, remote shopping is not without its drawbacks. Most prominent among such drawbacks is the lag time between purchasing an item and having it delivered. With the exception of digital goods that can be downloaded over the internet, most goods purchased by remote shopping need to be delivered to the purchaser's home or business. This can take days, if not weeks, and is subject to the intrinsic costs, hazards, unpredictability and obstacles of traditional parcel/package delivery and current logistics and transportation models.

Companies are attempting to minimize the delay between purchase and delivery and maximize customer satisfaction by offering same day delivery in certain cities. However, this can be very costly and inefficient as it requires a large number of vehicles and employees to be in reserve or on call to deliver items individually as they are purchased. This increases the delivery cost, and also increases traffic congestion and carbon emissions.

To improve delivery services and avoid drawbacks of conventional same day delivery, companies are continuously turning to the use of unmanned aerial vehicles (UAV)/drones. Low flying drones, such as quadcopters and octocopters, can be used to carry and deliver parcels directly to customers' locations, using global positioning system technology, machine vision, artificial intelligence, autonomous navigation, telemetry, metadata and/or commands from a remote operator. These drones promise to be more cost effective and environmentally friendly than human delivery and faster as they can bypass traffic and are not limited to following paved roads. As consumer demand for same day delivery rises, drones are rapidly becoming a viable technology for many delivery services and companies.

As the use of drones increases, needs have arisen for delivery systems and methods to aid in the deployment of fleets of drones and the storage and retrieval of packages to be delivered, and delivered, by the fleets.

Some drone delivery systems use structured systems and methods on one or both ends of the cargo delivery to autonomously load, unload, manipulate, store and secure cargo. Some embodiments of this invention relate to those systems and methods and their interactions with drones, cargo, and customers.

### SUMMARY OF THE INVENTION

A drone roost can include an outer shell and a top hatch to allow a drone to enter the interior of the drone roost. In some embodiments a drone roost can include a conveyor belt, a drone storage wheel with at least one drone storage shelf, a conveyor door, a solar panel, and/or a cargo elevator.

In some embodiments the drone storage shelf can include a package loading aperture. In some embodiments, the drone storage shelf is configured to secure, recharge and/or program a drone.

In some embodiments a drone roost can include a plurality of trays configured to move along at least one guiderail. In some embodiments, the drone roost can include a charging system. In some embodiments, the charging system is powered via a guiderail.

In some embodiments the drone roost is configured to be mobile and can include at least one pair of wheels.

Various methods of operating a drone roost are disclosed.

A storage facility can include an outer shell, a top aperture, a landing surface, a cargo delivery hatch, a gantry robot, an interior landing area, an interior storage area, a conveyor belt, an overhead camera, a delivery compartment, a cargo delivery hatch, a backstop located on one end of the conveyor belt, and/or a rolling cover door.

In some embodiments, the gantry robot includes a package gripper. In some embodiments the package gripper is a vacuum.

In some embodiments, a storage facility can include an outer shell, at least one landing tower, a package elevator located in the one landing tower, a cargo delivery door, and/or a shuttle, wherein the shuttle has several package storage compartments.

In some embodiments, the storage facility is a circular drone delivery station and storage facility including a rotating raceway with a rotating baseplate onto which at least one storage compartment is attached.

Various methods of operating a drone roost are disclosed.

A drone delivery mailbox system can include a chassis, a postal door, a parcel door, a conveyor belt, a pair of bumpers, a first leg, a second leg, a third leg, wherein the third leg is a traditional mail post, an outgoing mail flag, a street number label, a solar array, a user interface screen and/or a docking clamp. In some embodiments, the docking clamp is conductive and configured to charge a drone.

Various methods of operating a drone delivery mailbox system are disclosed.

### BRIEF DESCRIPTION OF THE DRAWINGS

FIG. 1 is a front partial cross-sectional perspective view of a large-scale drone roost.

FIG. 2 is a subassembly view of internal components of the large-scale drone roost of FIG. 1.

FIG. 3 is a front partial cross-sectional perspective view of the roost of FIG. 1 illustrating it interacting with a drone.

FIG. 4 is a front partial cross-sectional perspective view of a large-scale drone management system.

FIG. 5 is a front partial perspective view of a conveyor-based drone landing and cargo management system.

FIG. 6 is a front partial cross-sectional view of the conveyor-based drone landing and cargo management system of FIG. 5.

FIG. 7 is a front perspective view of a high-capacity drone delivery station with linear package storage.

FIG. 8 is a front cross-sectional perspective view of the high-capacity drone delivery station with linear package storage of FIG. 7.

FIG. 9 is a front perspective view of a high-capacity drone delivery station with circular package storage.

FIG. 10 is a front partial cross-sectional perspective of the high-capacity drone delivery station with circular package storage of FIG. 9.

FIG. 11 is a front perspective view of a drone delivery mailbox system.

FIG. 12 is a back perspective view of the drone delivery mailbox system of FIG. 11.

FIG. 13 is a side partial cross-sectional perspective view of the drone delivery mailbox system of FIG. 11

### DETAILED DESCRIPTION OF THE ILLUSTRATIVE EMBODIMENT(S)

### Drone Roosts

As drone deliveries become more ubiquitous, a need is arising for a high cargo volume central hub that dispatches packages. This hub could be located at a central warehouse, fast food restaurant delivery kitchen, big box retailer, local pharmacy, etc. In some of these cases, a fleet of drones is based at the central location. In some embodiments, a local restaurant, pharmacy, or other retailer can have a fleet of several drones, where a major e-commerce company can need several hundred drones based at a major distribution facility. In some applications of large-scale drone systems, a key challenge is to manage a large number of drones with a small physical footprint.

In at least some embodiments, it is beneficial for these drones to be sheltered from the weather, recharged, programmed with mission profiles, tested, automatically loaded with the packages they will deliver, safely launched, recovered, and/or have their logs downloaded once a mission is over. In some embodiments, these tasks can be accomplished at a roost.

In some embodiments, modular, easily deployable roosts can be integrated into cargo containers and deployed as needed. In some embodiments, robotic systems can be used to manage these drone fleets and can be integrated into existing buildings or package management systems. In some embodiments, the roost can use a robotic system to retrieve, secure, recharge and/or service the drones between missions.

In some embodiments, a centralized management roost can shelter, secure, recharge, update mission instructions and/or download logs from dozens or even hundreds of drones simultaneously. In some embodiments, roosts allow for mass launchings of up to one hundred drones per minute. In some embodiments, roosts allow for mass launchings of over one hundred drones per minute.

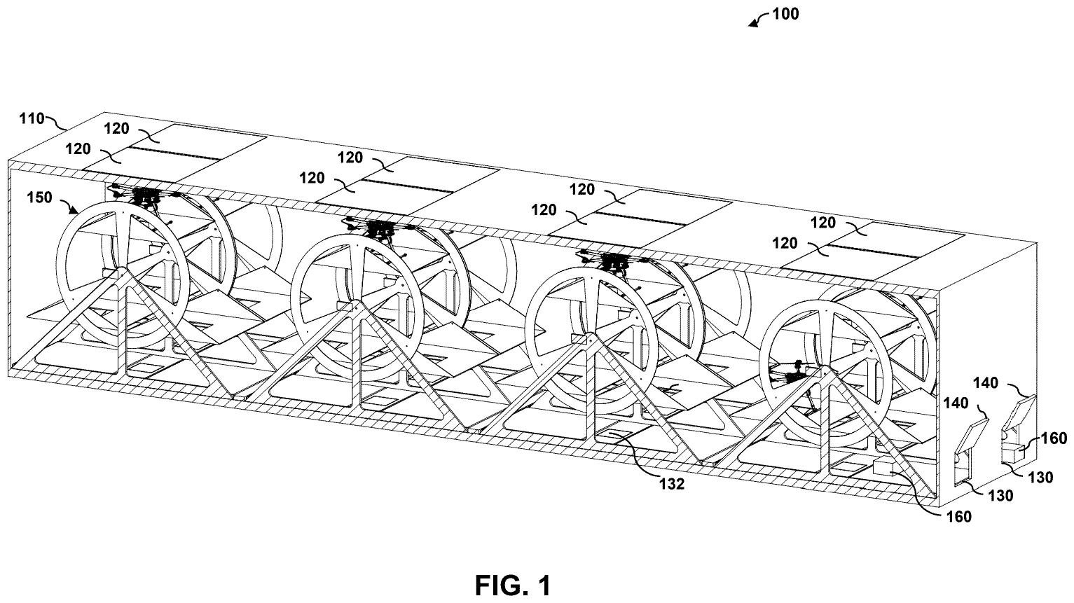

FIG. 1 is a perspective view of an embodiment of a large-scale drone roost 100. Drone roost 100 is configured to manage the ground support for a fleet of drones. In the embodiment illustrated in FIG. 1, drone roost 100 is capable of managing the ground support operations for up to twenty-four large cargo drones. In some embodiments, drone roost 100 is approximately the form factor of a standard forty-foot (12.19 m) cargo container conforming to the ISO 668 standard. Alternate embodiments could use twenty-foot (6.10 m), forty-eight-foot (14.63 m), or fifty three-foot (16.15 m) ISO 668 compliant containers, or physical enclosures of other types.

In some embodiments, drone roost 100 has outer shell 110 that provides mechanical support, weather protection and/or physical security for the drones being serviced inside. In some embodiments, outer shell 110 is made from a weather resistant, rigid, difficult to damage material like coated steel, aluminum, or carbon composites. In some embodiments, outer shell 110 can include one or more solar panels.

In the illustrated embodiment, drone roost 100 has eight top hatches 120 that allow drones to pass through as they are entering or exiting drone roost 100 for their various missions. In some embodiments, top hatches 120 are moved between their open and closed positions using motion control actuators such as, but not limited to, linear actuators, harmonic drives, hydraulics, pneumatics, belts, or chains.

In some embodiments, drone roost 100 includes two conveyor belts 130 that aid in the transfer of cargo between a drone and an external source/destination for the cargo such as, but not limited to, an automated warehouse. In some embodiments, drone roost 100 contains only one conveyor belt. In some embodiments, conveyor belt(s) 130 run the length of drone roost 100 under drone storage wheel(s) 150, transporting the packages to and from the drones and an external centralized warehouse facility.

In some embodiments, conveyor door(s) 140 can close to secure and weatherproof the interior of drone roost 100 when conveyor belt(s) 130 are not in operation. In some embodiments, conveyor doors 140 are moved between their open and closed positions using motion control actuators, such as but not limited to, linear actuators, harmonic drives, hydraulics, pneumatics, belts, or chains.

In some embodiments of drone roost 100, drones are stored on at least one drone storage wheel 150. In at least some embodiments, drone storage wheel(s) 150 can act similar to Ferris wheels.

In some embodiments of drone roost 100, about three large drones or twelve small drones can be serviced by drone storage wheel 150 with a roughly six foot (1.83 m) to eight foot (2.44 m) diameter. In some embodiments, drone storage wheel 150 can have a larger diameter between 8 feet (2.44 m). and 25 feet (7.62 m). In some embodiments, the large drones can have takeoff weights of up to 55 pounds (24.9 kg). In some embodiments, the small drones may have takeoff weights under 20 pounds (9.1 kg).

In some embodiments, drone storage wheel 150 turns, accumulating, charging, loading and/or launching drones as it goes. In some embodiments, drone storage wheel 150 is powered by a motor. In some embodiments, the motor is located at the hub of drone storage wheel 150.

In some embodiments, conveyor belt(s) 130 pass under at least one drone storage wheel and convey packages between an external warehouse and at least one cargo loading elevator 132. Cargo loading elevator 132 is a segment of conveyor belt 130 onto which a package 160 can be loaded, and then elevates to pass the package onto drone stored on drone storage wheel 150. The elevation of cargo loading elevator can use motion control systems such as leadscrews, belts, chains, rack & pinion drives, hydraulics, pneumatics, and/or other devices known in the art. Once package 160 is elevated to, and retained by the drone, cargo loading elevator 132 returns to a position substantially level with the rest of conveyor belt 130.

In some embodiments when package 160 travels from an external location (such as a warehouse) to be loaded onto a drone via drone roost 100, package 160 passes on conveyor belt 130, through conveyor door 140, and onto cargo loading elevator 132. In some embodiments, cargo loading elevator 132 raises package 160 up to drone storage wheel 150, where it is accepted by waiting drone 170.

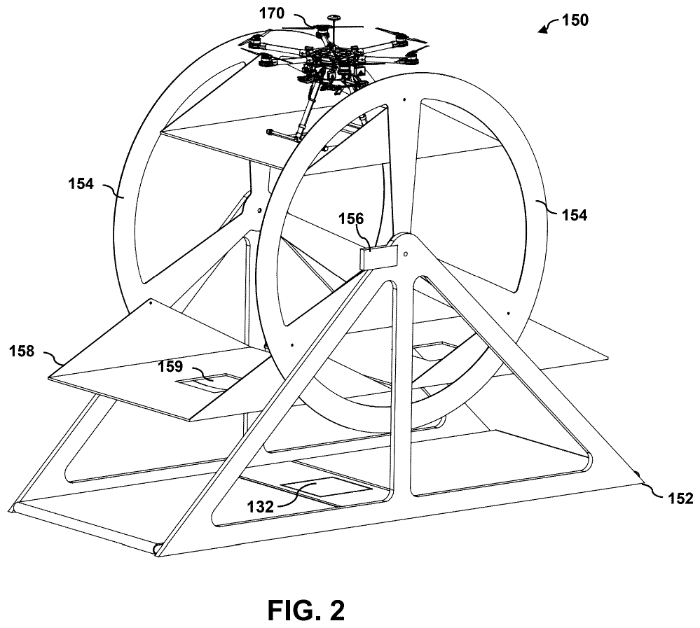

In some embodiments, such as the one shown in FIG. 2, at least one drone storage wheel 150 can include frame 152, two moving wheel frames 154, motor/sensor assembly 156, and/or at least one drone storage shelf 158. In some embodiments, at least one drone storage shelf 158 has a package loading aperture 159. In some embodiments, every drone storage wheel 150 can include any or all of the above components. In some embodiments, drone 170 is supported by at least one drone storage shelf 158 as wheel frames 154 are rotated by motor/sensor assembly 156 until package loading aperture 159 is substantially aligned with cargo loading elevator 132.

In some embodiments, drone storage shelf 158 has the ability to secure, recharge and/or program the drone it carries. In some embodiments, drone storage shelf 158 has a trapdoor on its bottom through which packages can be loaded or unloaded. In some embodiments, the trapdoor is centered on the bottom of drone storage shelf 158. In some embodiments, robotic equipment at the base of drone storage wheel 150 opens the trapdoors and manipulates the packages. In some embodiments, motor/sensor assembly 156 includes elements like sliprings or clock spring conductors that convey power and data to at least one drone storage shelf 158, and thence to drone 170 that is loaded onto it.

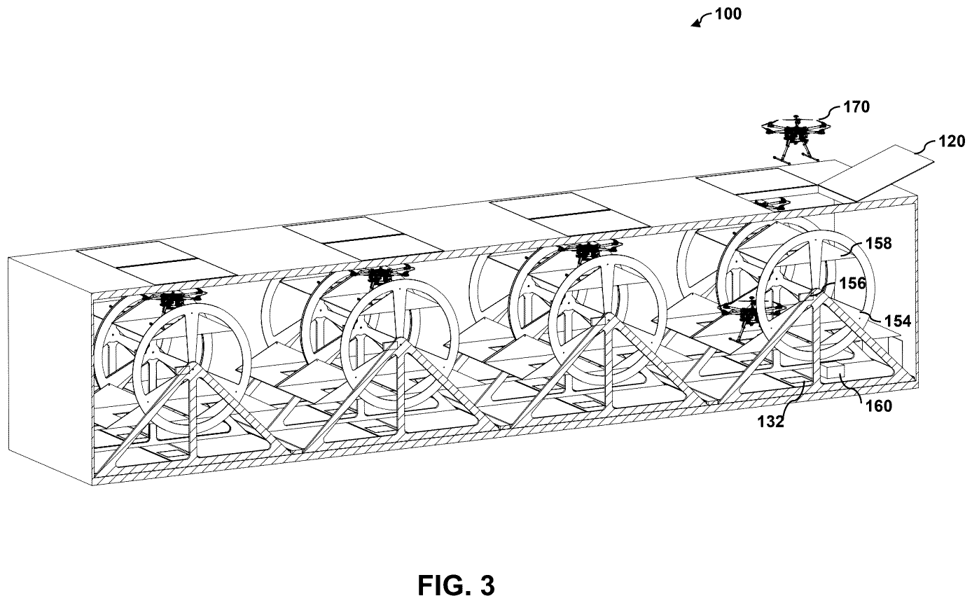

FIG. 3 shows another view of drone roost 100. In FIG. 3 drone 170 is shown landing in drone roost 100. In some embodiments, top hatch 120 is opened by a control system in anticipation of the arrival of drone 170. In some embodiments, drone 170 performs a precision landing on drone storage shelf 158, guided by cameras and fiducials, precision GPS, infrared tags, and/or similar technologies.

In some embodiments, once drone 170 is secured to drone storage shelf 158, drone storage wheel 150 is driven by motor/sensor assembly 156 to put drone storage shelf 158 into a position where cargo loading elevator 132 can raise package 160, through package loading aperture 159 to reload drone 170. In some embodiments, drone storage shelf 158 is shaped like a basket.

In some embodiments, drone roost 100 relies on gravity to keep any stored drones upright as wheel frame 154 rotates. These embodiments can have potential problems of unbalanced or non-centered drones tilting drone storage shelves 158. In some embodiments, to overcome this drawback, drone roost 100 uses a geartrain to aid in keeping each drone storage shelf 158 level. In some embodiments, the geartrain consists of three stages: a stationary hub gear affixed to the non-rotating structure of each wheel; a rotating gear fixed to each drone storage shelf 158 (in at least some embodiments this is the same diameter as the central stationary gear); and a series of planet gears to interconnect the previous two sets. In some embodiments, there can be half as many planet gears as shelf gears. In some embodiments, as drone storage wheel 150 rotates, the geartrain maintains drone storage shelf 158 in an upright and level orientation. but it does not suffer from potential imbalance, and it can allow more drones of a given size to fit onto a wheel of a certain diameter.

In some embodiments, once package 160 has been loaded onto a waiting drone, drone storage wheel 150 can be driven by motor/sensor assembly 156 to position the drone directly under top hatch 120 which can be opened. In some embodiments, a control system authorizes the drone to depart on its next mission.

In some embodiments, drone 170 can stay in drone roost 100 to recharge its battery before going on another mission. In some embodiments, drone 170 can stay in drone roost 100 to, among other things, be sheltered from outdoor weather, maintain a specific temperature, be protected from theft, and/or have its internal databases and software uploaded and/or downloaded.

In some embodiments, conveyor belt(s) 130 transfers package(s) 160 between drone storage wheel(s) 150 and a warehouse/restaurant/retailer that loads and unloads them. In some embodiments, at least eight drone storage wheels 150 capable of servicing and loading three large drones with takeoff weights of up to 55 pounds (24.9 kg) can fit in the volume of a standard forty-foot (12.19 m) cargo container. These embodiments allow a fleet of twenty-four drones to be installed next to a high-capacity cargo facility. In some embodiments, drone roost 100 can launch the twenty-four drones in about a minute. In some embodiments, a standard fifty-three-foot (16.15 m) container can be used, allowing for two additional eight-foot (2.44 m) diameter drone storage wheels and additional drones.

In some embodiments, as drone fleets grow, additional drone roosts 100 can be added and connected to the system, by transporting outer shell 110 in the same way other standard cargo containers are transported. In some embodiments, drone roost 100 can be permanently and/or semi-permanently installed in unused loading docks outside a warehouse or other commercial building.

In some embodiments, drone storage wheels 150 can be tucked into the interior of a building (such as one owned by a drone fleet operator). In some embodiments, drone storage wheel(s) 150 can be installed next to a drive-window of a fast-food restaurant or pharmacy. In some embodiments, the same staff members who tend the drive-through window can load and unload the drones. In some embodiments, package robotics and/or conveyor belts can be used to aid in the loading/unloading. In some embodiments, a similar system can be installed in a small shed adjacent to a building, with a somewhat longer conveyor belt providing access for the packages.

In some embodiments, drone roost 100 is mobile, allowing for drone roost 100 to be loaded with drones at a first location, such as a warehouse. The drone roost 100 can then be transported to a second location for mass deliveries. In some embodiments, the available volume in drone roost 100 can be split between a smaller number of wheels and robotic package storage systems. At least some of these embodiments allow the tailoring of how drone storage areas and package storage areas are divided in drone roost 100.

Distributed delivery stations, such as discussed above are only one aspect of drone ground support ecosystems. There is also a need for centralized management of large-scale fleets of drones. In some of these systems where fleets of drones are deployed, there is no need for significant, if any, package/payload handling capabilities. Some examples of this type of drone deployment include, but are not limited to, when large fleets of drones are used for surveillance (for example military, police, and/or perimeter security patrol of large installations), electronic news gathering, advertising, drone racing, and/or aerial lightshows.

In some embodiments of high-capacity drone delivery systems, a centralized management roost, such as drone roost 200 can manage drones when they are not flying among cargo-handling delivery stations, for example when fleet members need recharging or shelter from severe weather.

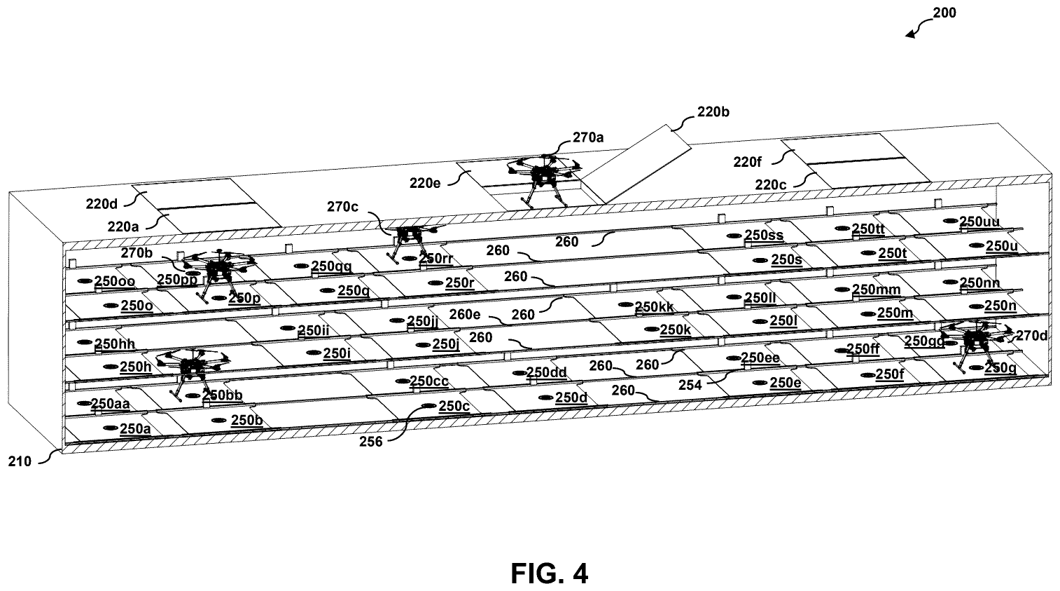

FIG. 4 is a cross-sectional view of drone roost 200. Drone roost 200 as shown, does not include the conveyor belts and automatic package loading robotics elements shown in drone roost 100. Instead drone roost 200 has higher capacity to store and charge more drones than drone roost 100, assuming the overall volume of the two roosts are equivalent. In some embodiments, drone roost 200 occupies approximately the form factor of a standard forty-foot (12.19 m) cargo container. Alternate embodiments could use twenty-foot (6.10 m), forty-eight-foot (14.63 m), or fifty three-foot (16.15 m) ISO 668 compliant containers, or physical enclosures of other types. In some embodiments, drone roost 200 has outer shell 210 that provides mechanical support, weather protection and/or physical security for the drones being serviced inside. In some embodiments, outer shell 210 could be made from coated steel, aluminum, and/or composite materials. In some embodiments, outer shell 210 can include one or more solar panels.

In some embodiments, drone roost 200 can shelter and store up to forty-two large drones or up to four hundred small drones in a standard forty-foot (12.19 m) cargo container. In some embodiments, drone roost 200 operates through the use of a number of moving trays arranged in layers across the width of a cargo container. In some embodiments, these trays can be equipped with actuators and/or slides that permit the trays to independently move backward and forward within the drone roost 200. In some embodiments, drone roost 200 has three layers of two ranks of seven trays each, for a total of forty-two moving trays, each managing a single drone.

In some embodiments, such as the one shown in FIG. 4, drone roost 200 has six top hatches 220a-220f that allow drones to pass through as they are entering or exiting drone roost 200.

In some embodiments, a number of moving trays are arranged in ranks and layers to store drones. In some embodiments, such as the one shown in FIG. 4, the twenty-one trays in a first rank are labeled 250a-250u and the twenty-one trays in the second rank are labeled 250aa-250uu.

In some embodiments, each tray consists of a four-foot (1.22 m) by four-foot (1.22 m) drone landing pad, capable of moving on a number of horizontal rails. In some embodiments, such as the one shown in FIG. 4, the trays move along a number of guiderails 260. In some embodiments, these guiderails include power busbars, rack and pinion drives, and/or toothed belt drives to power and move the trays. The size of the trays can vary depending on their intended use.

In some embodiments, motors and/or sensors, such as motor 254, provide motion control for each individual tray to drive them laterally along the guiderails. In some embodiments, charging devices, such as charging system 256, extract energy from guiderail(s) 260, control and regulate it, and/or couple it to at least one drone to provide recharging capabilities. In some embodiments, charging devices provide mass recharging capabilities to more than one drone. In some embodiments, charging system 256 can use either electrical contacts and/or wireless charging technologies.

In some embodiments of operation of drone roost 200, a control system plans the sequence of which drones 270a-270e are launched and/or which trays are used to recover incoming drones as they arrive. In the embodiment shown in FIG. 4, drone 270a is arriving after completing a mission. In the shown embodiment, drone 270a is seeking shelter and charging before being dispatched for its next mission. In some embodiments, when drone 270a reports it is hovering over drone roost 200 top hatch 220b automatically opens. In the shown embodiment, drone 270a is designated by the control system to land on tray 250d, in the bottom layer of the near rank. In at least some embodiments, drone 270a can perform a precision landing through top hatch 220b, descending vertically through the gap between trays 250r and 250s, further descending through the gap between trays 250j and 250k until it touches down on designated tray 250d. In at least some embodiments, at this point charging system 256 can extract energy from guiderails 260(s) to begin a high current recharge of the batteries in drone 270a. In at least some embodiments, top hatch 220b is then closed and locked, completing the drone landing operation. In some embodiments, the trays above a selected landing tray are driven to positions where they do not interfere with the ability of a drone to pass down from the open hatch, creating a clear column for the drone to descend through to reach its targeted pad.

In some embodiments to launch a drone from drone roost 200, the trays are moved to align the desired tray under one of top hatches 220a-220f. In the embodiment shown in FIG. 4, tray 250p carrying drone 270b is already below hatch 220a, so to launch it hatch 220a can be opened and clearance can be issued by the control system. Drone 270b can then fly straight up until it clears hatch 220a, which then closes. At this time drone 270b can begin its mission, or hover in a nearby airspace designated by the control system until other drones in the fleet or formation are launched by drone roost 200.

In some embodiments, if a drone is not located under one of the hatches, such as drone 270c, a tray, such as tray 250rr, can be driven one position along guiderail(s) 260 until it aligns under a top hatch, for example 220e. Once aligned, the hatch is opened by the control system and drone 270c can launch using the same procedure as drone 270b.

In some embodiments, such as the one shown in FIG. 4, to launch drone 270d from tray 250g, several operations can be performed. First, trays 250s, 250t, 250k 2501 and 250m are moved to the left to create a free column above the bottom level of storage under top hatch 220c. Then, trays 250e, 250f and 250g are moved one place to the left to locate drone 270d under top hatch 220c, creating a free column through which drone 270d can pass.

In some embodiments, control algorithms manipulate trays 250a-250u and 250aa-250uu to coordinate their operation to efficiently recover, store and/or launch drones. In some embodiments, if a mass drone launch is desired (for example to manage a large-scale emergency, support a large-scale fleet delivery, and/or in preparation for a drone performance like a lightshow or race) these algorithms can operate the trays full of drones to permit the launching of three from the front rank simultaneously off of trays 250a-250u, followed rapidly by launching three from the back rank (trays 250aa-250uu). In some embodiments, as the back rank launches, trays in the front rank move laterally to locate more ready drones under the top hatches. By repeating these operations, all forty-two drones that can be stored in drone roost 200 shown in FIG. 4 can be launched or recovered in seven rapid waves. In some embodiments, this allows for the emptying or refilling drone roost 200 in less than two minutes.

This rapid deployment can aid in applications that require the formation flying of dozens of drones simultaneously to complete a collective mission. In some embodiments, if a drone roost takes too long to launch its full complement, the first drones to be launched may have used a significant portion of their energy reserves waiting for the last members of their formation fleet to launch. Similarly, in some embodiments, it is equally important that drone roost 200 be capable of recovering its full complement of drones in a few minutes in several parallel waves, because the drones' energy reserves are often nearly exhausted after a long collective mission, and there is little to no time to hover waiting for a long sequential process.

In some embodiments of drone roost 200, to perform a mass launch from a roost full of forty-two fully-charged drones, the trays on the top layer are driven to a position where the first six drones to be launched are directly under the hatches, which are opened. In some embodiments of drone roost 200 up to six drones can be launched simultaneously. In some embodiments, the top trays are indexed one position and another six launches occur, and so on until the entire first level is empty. In some embodiments, the empty trays on the top level then move to positions that are not below a hatch, creating six open columns to the second level. In some embodiments, the second level empties the same way the first one did, followed by the third level, permitting the entire fleet to be launched in less than two minutes.

In some embodiments, once their collective missions are complete, the drones return to the roost, and robotic equipment aligns the trays, opens the hatches, recovers all the drones in rapid sequence, and/or closes the hatches to secure and protect the drones inside roost 200.

In other embodiments, various numbers of drones, layers, openings, and/or trays can be used.

In some embodiments, multiple drone roosts 200 can be networked, permitting the management of fleets of thousands of drones.

### High-Capacity Cargo Storage Facilities

In some drone delivery networks, a system is needed to securely manage a large number of packages waiting to be shipped on the sending end or waiting to be retrieved on the receiving end. Scalable arrays of package storage lockers enable these systems to be configured with the right number of lockers to manage the anticipated demand. Scalability can be important in situations where there is high traffic volume, many different delivery companies share a single landing station, and/or where package dwell times are long.

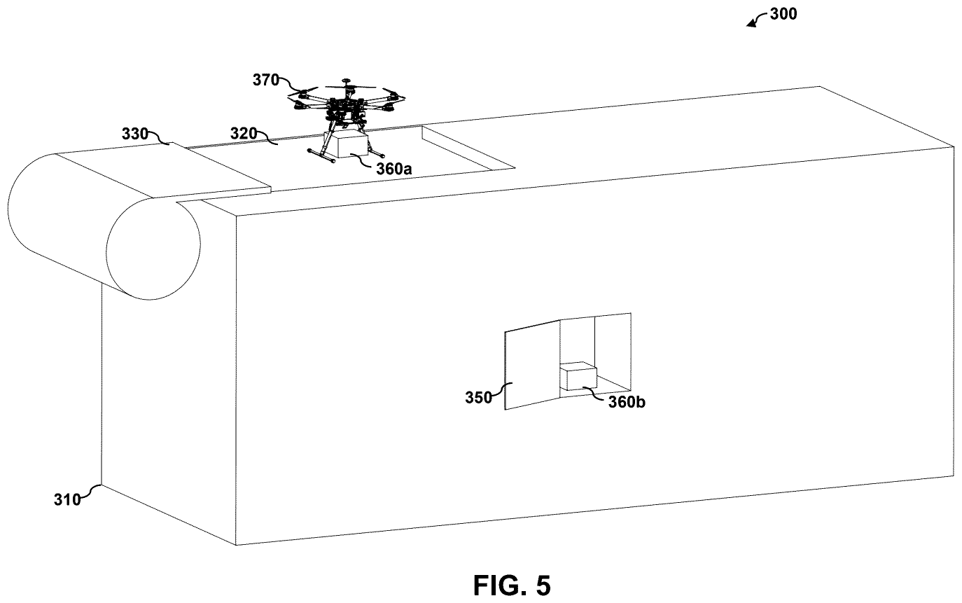

FIG. 5 illustrates an embodiment of high-capacity storage facility 300. In some embodiments, outer shell 310 has approximately the form factor of a standard twenty-foot (6.10 m) cargo container, often made from coated steel. In some embodiments, outer shell 310 can include one or more solar panels. Alternate embodiments could use forty-foot (12.19 m), forty-eight-foot (14.63 m), or fifty three-foot (16.15 m) ISO 668 compliant containers, or physical enclosures of other types.

In some embodiments, top aperture 320 reveals a large landing surface. In some embodiments, rolling cover door 330 covers aperture 320 when no drones are expected. In some embodiments, cargo delivery hatch 350 allows package senders and/or receivers (either human or robotic) to retrieve and send packages, while staying safely away from drone 370 and the robotic actuators within high-capacity storage facility 300.

In the embodiment shown in FIG. 5, package 360a is being delivered by drone 370 through aperture 320. In the embodiment shown in FIG. 5, package 360b is ready for pickup by a user of the system. In some embodiments, top internal mechanisms of high-capacity storage facility 300 are capable of storing and/or retrieving a large number of additional packages.

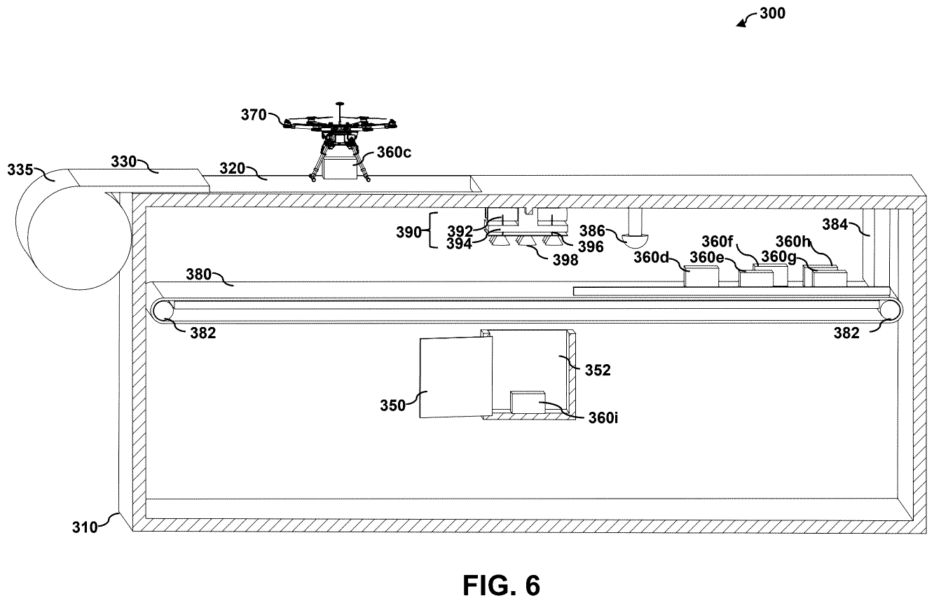

FIG. 6 shows the internal parts of high-capacity storage facility 300. In some embodiments, drone 370 enters and leaves high-capacity storage facilities 300 through aperture 320. In some embodiments, rolling door 330 is stored in and driven by an actuator in door housing 335, and can be extended to cover, secure, and/or waterproof aperture 320, or retracted to expose aperture 320 to permit drone 370 to access the interior of high-capacity storage facility 300. In some embodiments this is done under the direction of a system controller.

In some embodiments, when drone 370 carrying package 360c approaches high-capacity storage facility 300, rolling cover door 330 opens to reveal aperture 320. In some embodiments, aperture 320 measures approximately eight feet (2.44m) wide by eight feet (2.44m) long. In some embodiments, drone 370 descends through aperture 320, and lands on conveyor belt 380. The dimensions of the landing surface can vary based on its intended use.

In some embodiments, conveyor belt 380 is driven by computer controlled motorized roller(s) 382. In some embodiments, conveyor belt 380 covers both the landing surface and the package storage area. In some embodiments, conveyor belt 380 is a continuous belt, similar to a treadmill, also called a flat belt conveyor. In some embodiments, conveyor belt 380 is a roll-to-roll belt similar to a player piano roll. In some embodiments, conveyor belt 380 is resistant to moisture, puncture, and abrasion, and has appropriate strength, frictional and elasticity properties to move drones with takeoff weights of up 55 pounds (24.9 kg) along with a number of packages. In some embodiments, conveyor belt 380 runs over rollers on either side that move it horizontally. In some embodiments, conveyor belt 380 is supported from below with a low friction plate. In some embodiments, such as the one shown in FIG. 6, half of conveyor belt 380 can be exposed to the sky by opening rolling door 330, creating a large landing surface for the drone. In some embodiments, this landing surface is approximately eight feet (2.44 m) by ten feet (3.05 m). The dimensions of the landing surface can vary based on its intended use.

In the embodiment illustrated in FIG. 6, packages 360d-360h are awaiting pickup and are supported by conveyor belt 380 in a cargo storage area. In some embodiments, backstop 384 provides a positive limit to the travel of packages 360d-360h as conveyor belt 380 moves them from the landing zone of conveyor belt 380 that is under aperture 320 to the cargo storage area.

In some embodiments, an overhead camera 386 captures wide-angle images of conveyor belt 380 and the configuration of packages 360d-360h resting upon it.

In some embodiments of operation of high-capacity storage facility 300, drone 370 releases package 360c onto conveyor belt 380, consults the control system, and flies away. In some embodiments, motors in rolling door housing 335 drive rolling door 330 to close aperture 320 and cover, secure, and weatherproof the internal volume of high-capacity storage facility 300. In some embodiments, at this point, conveyor belt 380 is driven by motorized roller(s) 382 to bring package 360c into the cargo storage area. In at least some embodiments, as this is done, packages 360c and 360d-360h already on conveyor belt 380 are driven until they contact backstop 384, and bunch up in contact with each other. In some embodiments, the storage area is located away from aperture 320.

In some embodiments, friction between the bottom of packages 360c-360h and conveyor belt 380 is controlled so packages safely skid along the belt as it is driven. In some embodiments, this control is accomplished by selecting the material for the top surface of conveyor belt 380, its speed, and its static and dynamic frictional interactions with the materials used in packages 360.

In some embodiments, high-capacity storage facility 300 includes gantry robot 390. In some embodiments, gantry robot 390 includes overhead guiderails 392 with integrated linear actuators that move carriage 394 in a direction perpendicular to the motion of conveyor belt 380. In some embodiments, gantry robot 390 has two degrees of freedom. In some embodiments, gantry robot 390 has a moving carriage 394 that lowers package gripper 398 assembly on cables.

In at least some embodiments, linear actuators in guiderails 392 could be leadscrews, belts, chains, rack and pinion, harmonic drives, hydraulic, pneumatic and/or another motion control technology. In some embodiments, a Z-axis actuator 396, attached to carriage 394 is able to raise and lower gripper 398. In some embodiments, Z-axis actuator 396 could be a pantograph, a drum and cable, and/or a linear actuator. In some embodiments, gantry robot 390 in conjunction with conveyor belt 380 represents a three degree of freedom movement capability, where one degree is the left and right motion of conveyor belt 380, the second degree is the in and out motion created by linear actuators in guiderails 392, and the third degree is the up and down motion from Z-axis actuator 396. The combination of these three degrees of freedom enables gripper 398 to lift one of packages 360d-360h over the top of another package, move the entire array of packages left and right, and set the selected package down in another position in the array, thus enabling it to rearrange packages on conveyor belt 380.

In some embodiments, package gripper 398 is pneumatic/vacuum actuated. In some embodiments, package gripper 398 uses magnets or mechanical actuators to attach to packages.

In some embodiments, cargo delivery hatch 350 with cargo delivery locker volume 352 is located to the side of conveyor belt 380 such that package gripper 398 carrying package 360i can be moved to the side of conveyor belt 380 by guiderails and actuators and lowered into delivery compartment 352 by z-axis actuator 396.

Traditional package locker-based systems usually have one locker per package and are often inefficient or unable to handle many packages of various sizes. High-capacity storage facility 300 uses the combination of conveyor belt 380, linear actuator guiderails 392, and/or Z-axis actuator 396 to move packages in three dimensions. This enables high-capacity storage facility 300 to retrieve packages released by a drone, add them to an array of stored packages, retrieve them on command, and/or rearrange them as necessary to optimize storage efficiency.

In some embodiments, when a package such as package 360c is dropped onto conveyor belt 380 by drone 370, conveyor belt 380 drives so the packages bunch up as several columns of packages hitting backstop 384. As conveyor belt 380 continues to drive, the packages are packed tightly together as conveyor belt 380 slides below them. In some embodiments, this completely clears the landing area of any packages allowing additional packages to be delivered. In some embodiments, at this point the conveyor drives the packages under overhead camera 386 allowing overhead camera 386 to take an image of the configuration of the packages on conveyor belt 380, and to identify the packages by their attached barcode or QR Code. In some embodiments, overhead camera 386 is a wide field of view overhead camera.

In some embodiments, control software and at least one algorithm determines the size of each package from the images taken by overhead camera 386, and modifies the storage plan to optimize, or at least improve, the use of space in the package storage area. This can be useful in high-capacity package storage scenarios where space on conveyor belt 380 is limited, and/or where individual packages 360 have a large footprint on conveyor belt 380. In some embodiments, one example of this optimization could be to lift a package from the middle of the storage array and relocate it to a different row or column position by coordinating conveyor belt 380, linear actuator guiderails 392, and/or Z-axis actuator 396 to move packages from their current position to the head of one of the columns of packages. In some embodiments, at this point, conveyor belt 380 is driven until the new configurations of packages hits backstop 384, thus reconfiguring and optimizing, or at least improving, the use of available storage space. In some embodiments, approximately eight feet (2.44 m) of the length of conveyor belt 380 can be used for package storage. Multiplying this package storage length by the width of conveyor belt 380 which in some embodiments is approximately seven feet (2.13 m) allows a densely packed two-dimensional array of packages covering a conveyer belt area of approximately 8′×7′=56 square feet (5.20 m²). In some embodiments, there is space for over one hundred packages (approximately 8″×8″ in size) (20.32 cm×, 20.32 cm) or several hundred smaller packages (approximately 4″×4″ size) (10.16 cm×10.16 cm) in this package storage array waiting for retrieval. The length and width of the conveyor belt 380 can vary depending on its intended use.

In some embodiments, when a package recipient arrives to retrieve a delivered package, the system consults its records to determine the position of the package in the stored array. In some embodiments, the conveyor belt 380 is driven so the desired package is under gantry robot 390. In some embodiments, the carriage moves to center package gripper 398 over the desired package. In some embodiments, the cables lower package gripper 398, the vacuum and/or other package retention system is engaged, and the package is lifted out of the array by the Z-axis actuator. In some embodiments, the carriage moves such that the cables can winch the package down the delivery shaft into cargo delivery locker volume 352, release package gripper 398, and winch package gripper 398 back up to the carriage. In some embodiments, cargo delivery hatch 350 then opens and/or unlocks, and the recipient can collect the package.

In some embodiments, at this point, the system can reorganize the package storage array to maximize, or at least improve its efficiency in a new configuration that no longer includes the recently-collected package. In some embodiments, this is accomplished by using a combination of conveyor belt 380 to drive the package array horizontally, the carriage to move packages up and down, and package gripper 398 to pluck a selected package out of the array, hold the package above the rest of the packages while the carriage and conveyor belt 380 relocate the rest of the packages, and then set the selected package down in its new position. In some embodiments, the array is driven back until it hits backstop 384, while overhead camera 386 photographs the entire new storage configuration. In some embodiments, based upon the images acquired by the wide field of view camera, fine adjustments can be made to the location of each package in the array to reduce the friction of their sidewall contact, reducing the force required for package gripper 398 to remove a package from the array for delivery.

In some embodiments, when the system anticipates a package is to be retrieved, a similar process is followed. In some embodiments, conveyor belt 380 is driven so overhead camera 386 can photograph the configuration of the waiting packages. In some embodiments, the location of the desired package is determined, and conveyor belt stops so the selected package is under gantry robot 390. In some embodiments, linear actuator rails 392 drive carriage 394 so package gripper 398 is aligned with the selected package in a column of packages. In some embodiments, Z-axis actuator 396 lowers package gripper 398 from carriage 394 until it contacts the selected package. In some embodiments, gripper 398 is activated to grasp the selected package, and/or Z-axis actuator 396 raises it to the top of its travel. In some embodiments, linear actuator 392 drives carriage 394 to a forward position, aligning it over the top of delivery compartment 352. In some embodiments, Z-axis actuator 396 then lowers package gripper 398 alongside and below the level of conveyor belt 380 until the selected package contacts the floor of delivery compartment 352. In some embodiments, package gripper 398 is deenergized releasing the selected package. In some embodiments, gantry robot then returns all of its actuators to their home position, and conveyor belt 380 drives all packages against backstop 384. In some embodiments, the place in the column that was occupied by the selected package is closed up during this operation, freeing up space at the head of that column for additional packages. In some embodiments, the package recipient can then instruct cargo delivery hatch 350 to open, and the selected package is retrieved, completing the delivery operation.

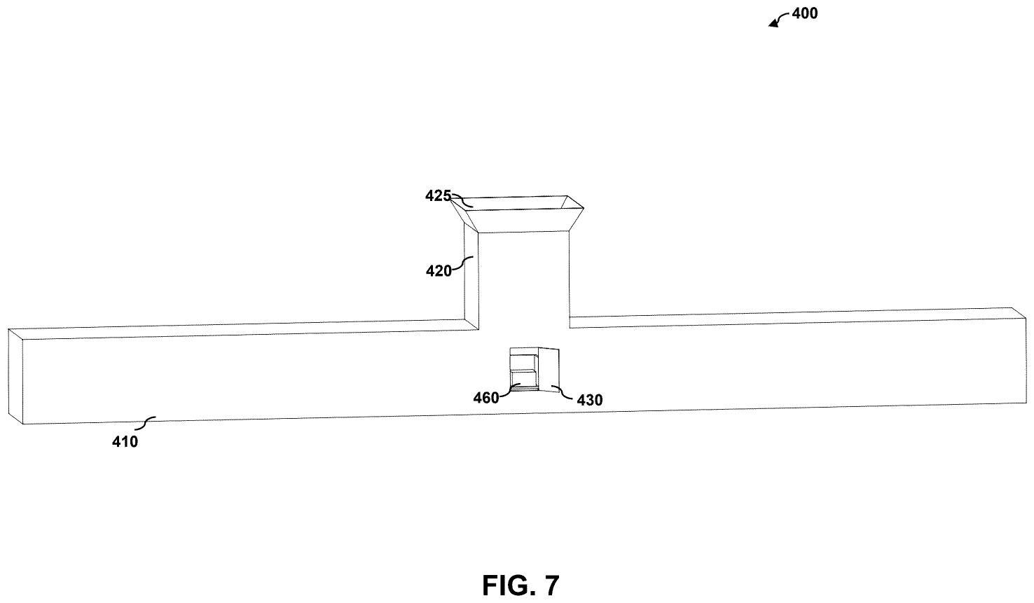

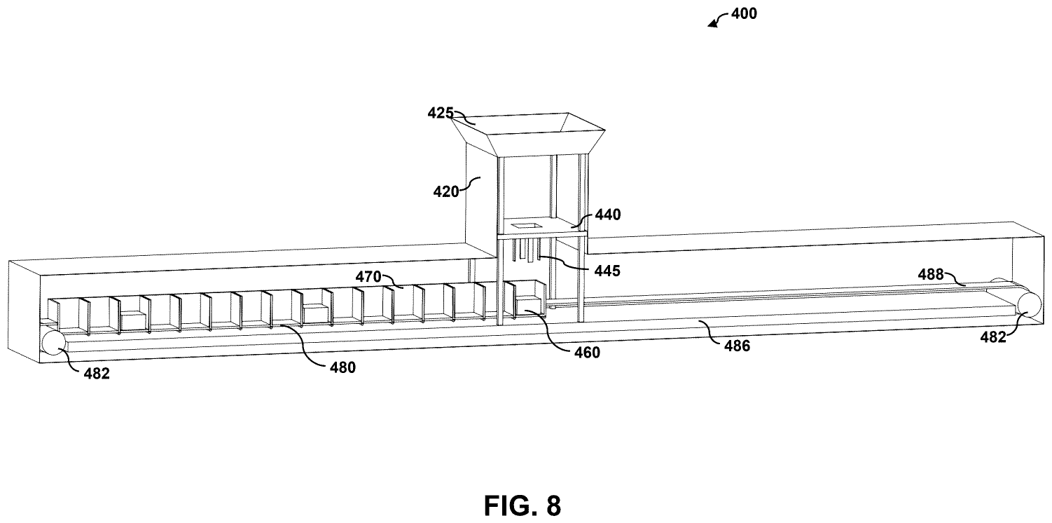

FIG. 7 and FIG. 8 illustrate another version of high-capacity storage facility 400. In some embodiments, high-capacity storage facility 400 includes outer shell 410 to protect, weatherproof and/or secure its contents. Outer shell 410 could be made from coated steel, aluminum, and/or composite materials. In some embodiments, outer shell 410 can include one or more solar panels.

In some embodiments, landing tower 420 elevates drone landing surface 425 to a height that can separate drones from bystanders. In some embodiments, landing tower 420 houses robotic equipment that transfers packages between drones and internal storage lockers. In some embodiments, package delivery door 430 opens upon a signal from a package recipient permitting the recipient to retrieve package 460. In some embodiments, a package shuttle system is housed in the long horizontal portion of outer shell 410.

In some embodiments, such as shown on FIG. 8, package elevator 440 moves packages vertically within landing tower 420. In some embodiments, package gripper(s) 445 grasp packages as they are transferred between drone landing surface 425 and package storage compartments 470.

In some embodiments, packages are stored in a number of package storage compartments 470 on moving shuttle 480. In some embodiments, shuttle 480 is driven forward and backwards by powered roller(s) 482 on track 486 by belt 488. In some embodiments, alternate drive technologies, such as but not limited to tires, rail wheels, rack and pinion, chain, hydraulic or pneumatic drives are used to move shuttle 480.

In some embodiments, shuttle 480 has several package storage compartments 470. In some embodiments, shuttle 480 has sixteen package storage compartments 470. In some embodiments package storage compartments 470 are 10″ (25.4 cm) wide. In some embodiments, the width of package storage compartments 470 varies between 6″-16″ (15.24 cm-40.64 cm). In some embodiments, track 486 is about twenty-six feet (7.92 m) long. In some embodiments, track 486 can be over 100 feet (30.48 m) long.

In some embodiments, during operation package 460 is delivered via a cargo drone to landing surface 425. In some embodiments, this delivery could be with a full landing, a touch-and-go drop and/or via a hover and winch down process. In some embodiments, elevator 440 in conjunction with package gripper(s) 445 accepts package 460 from the drone and moves it into tower 420. In some embodiments, system control software selects one of the many package storage compartments 470 and instructs powered roller(s) 482 to move shuttle 480 laterally until the selected storage compartment 470 is directly below package gripper(s) 445. In some embodiments, elevator 440 descends gripper(s) 445 into selected package compartment 470, releases package 460, and ascends up to a position ready for another drone delivery.

In some embodiments, when a user arrives to retrieve package 460, system control software verifies the user's identity, and instructs powered roller(s) 482 to drive shuttle 480 until the package storage compartment 470 containing package 460 aligns with cargo delivery door 430. In some embodiments cargo delivery door 430 is automatically opened, and the user can retrieve package 460, completing the delivery operation.

In some embodiments, high-capacity storage facility 400 can be built into street furniture, set alongside buildings, located on rooftops, and/or partially buried in the ground. In some embodiments, high-capacity storage facility 400 offers speed, efficiency, and cost advantages over other high-capacity landing station designs.

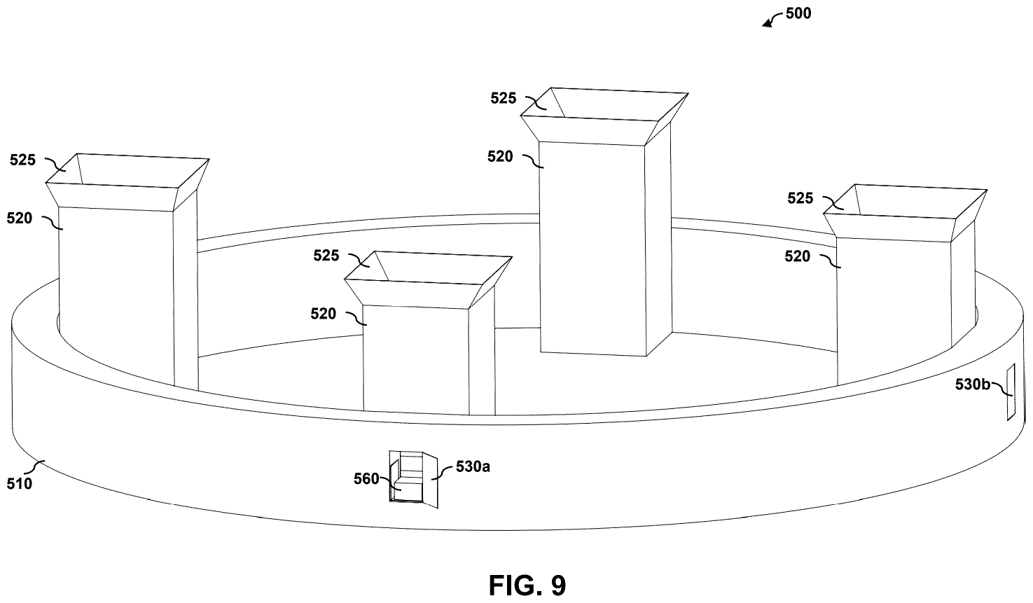

In some embodiments, circular drone delivery station and storage facility 500 of FIG. 9 works similar in operation to high-capacity storage facility 400 of FIG. 7. In some embodiments, circular drone delivery station and package storage facility 500 offers advantages regarding performance, capacity efficiency and cost. In some embodiments, circular drone delivery station and storage facility 500 takes the linear shuttle of FIG. 7 with package compartments and bends it into a continuous circular raceway. In some embodiments, circular drone delivery station and storage facility 500 integrates one or more drone landing stations 520 with a circular raceway package storage system contained in housing 510. In some embodiments, at least one drone landing station 520 incorporates drone landing surface 525 capable of accepting, centering, and loading/unloading drones via internal robotic elements and software control.

In some embodiments, circular drone delivery station and storage facility 500 incorporates a number of delivery doors such as delivery door 530a and delivery door 530b through which users retrieve their stored packages and/or insert packages for drone shipment. Delivery door 530a is shown in its open position, revealing package 560.

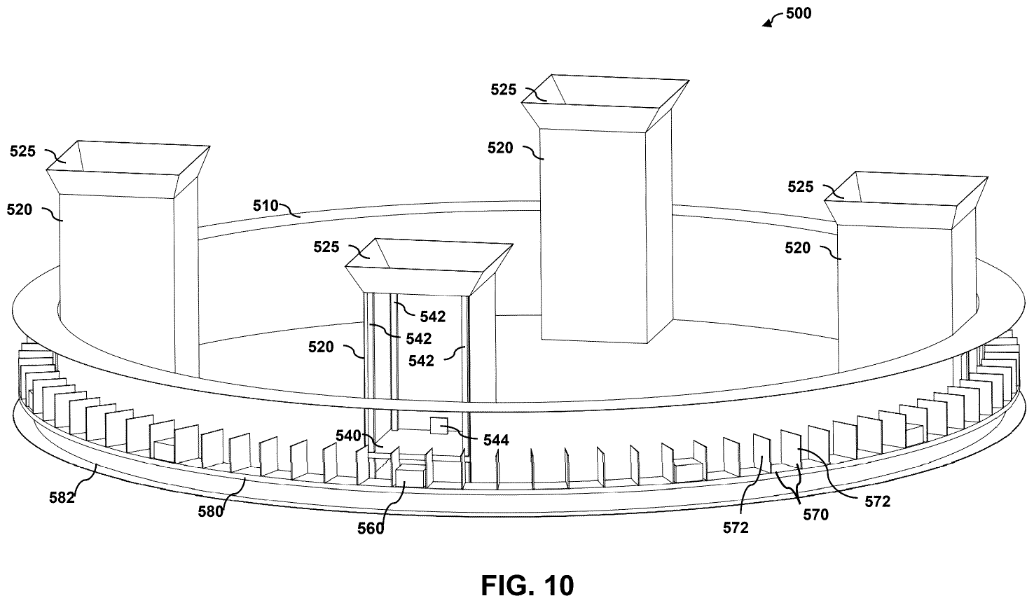

In some embodiments, such as shown on FIG. 10, circular drone delivery station and storage facility 500 has rotating raceway 580 that moves in a circular motion on circular track 582 enclosed within housing 510. In some embodiments, raceway 580 consists of a rotating baseplate onto which a number of package storage compartments 570 are attached. In some embodiments, package storage compartments 570 are delineated by vertical partitions 572 that separate package storage compartments 570 from each other.

In some embodiments, rotating raceway 580 has a diameter of roughly 25 feet (7.62 m). In some embodiments, the diameter of rotating raceway 580 can be between 6 feet (1.82 m) to over 100 feet (30.48 m). In some embodiments, rotating raceway 580 can store up to ninety-six packages up to 10 inches (25.4 cm) in width. In some embodiments, rotating raceway 580 can store over a thousand packages.

In some embodiments, rotating raceway 580 includes at least one rail to provide power. In some embodiments, rotating raceway includes at least two rails to provide power. In some embodiments, at least one railcar rides the rails. In some embodiments, the rail car is pie-shaped. In some embodiments, eight railcars are used. In some embodiments, the railcars are connected in a continuous circle. In some embodiments, at least one motors picks power up from the rails and drives the whole package storage assembly in a circle.

In some embodiments, a modified centering top on the landing station centers the package left-right, and then a long pusher actuator shoves the package into one of package storage compartments 570 on the raceway through an inner door and package funnel.

In some embodiments, the racetrack indexes to select individual packages, and the user can retrieve them through one or more package retrieval doors.

In some embodiments, the track can be buried into a hillside and/or under a plaza, exposing only the landing pad and cargo retrieval door. This can improve land use and aesthetics.

In some embodiments, four landing stations 520 are distributed around the circular track at different levels. In some embodiments, this creates a stack of four levels of packages utilizing the same raceway. In some embodiments, this can improve package throughput and storage capacity by up to four times, when compared to a single level design. These multiple levels add redundancy to the system and increase storage capacity.

The package storage capacity of these systems depends upon several factors. In some embodiments, the maximum package size that can fit into a storage compartment 570 can range from approximately six inches cubed (98.32 cm³) to sixteen inches cubed (262.19 cm³), and more packages can fit if the maximum size handled is smaller. In some embodiments, another factor affecting the storage capacity is the inner circumference of raceway 580. Larger diameter raceways have more storage compartments 570, and therefore have higher storage capacity. In some embodiments, raceway 580 can carry multiple layers of package storage compartments 570. In some embodiments, the number of layers range from one to six layers, further multiplying the overall storage capacity.

In some embodiments, raceway 580 is driven around track 582 by a set of servomotors coupled to the raceway through wheels, cogs, belts, and/or other motion control techniques. In some embodiments, track 582 keeps raceway 580 centered in housing 510, preventing, or at least reducing the chance of raceway 580, vertical partition(s) 572, and/or packages 560 from contacting the inside of housing 510. In some embodiments, track 582 maintains precise alignment with the package manipulation elements in drone landing station(s) 520.

In some embodiments, drone landing station(s) 520 includes elevator platform(s) 540 guided by upright linear actuator(s) 542. In some embodiments, package manipulator 544 is capable of pushing package(s) 560 from elevator platform 540 into package storage compartment 570. In some embodiments, package manipulator is capable of removing package(s) 560 from package storage compartment 570 and loading it onto an elevator to be raised up to drone landing surface 525 for loading onto a cargo drone.

In some embodiments of operation of circular drone delivery station and storage facility 500 a drone carrying package 560 lands on landing surface 525 and releases the package. In some embodiments, elevator 540 lowers package 560 into the body of drone landing station 520 until it is substantially level with raceway 580. In some embodiments, a control computer selects an empty package storage compartment 570 and rotates raceway 580 on track 582 to align the selected package storage compartment with package manipulator 544. In some embodiments, package manipulator pushes package 560 off of elevator 540, and into the selected package storage compartment 570. In some embodiments, at this point, raceway 580 can rotate to service other package storage requests from landing station(s) 520, and elevator 540 can be raised up to the level of landing surface 525 in preparation for the next drone arrival.

In some embodiments, a user of circular drone delivery station and storage facility 500 retrieves a stored package by entering a request into a control computer. In some embodiments, raceway 580 rotates on track 582 until the selected package is aligned with a package delivery door such as package delivery door 530a. In some embodiments, package 560 can then be retrieved, and the delivery operation is complete.

In some embodiments, circular drone delivery station and storage 500 has extendable features. In some embodiments, package manipulator 544 can be modified to both push and pull packages between elevator 540 and package storage compartment 570, allowing package sending as well as receiving.

In some embodiments, raceway 580 can be expanded into multiple levels. In some embodiments, raceway 580 can have up to four layers of package storage compartments 570 stacked upon each other, quadrupling the capacity of raceway 580 from the approximately one hundred packages as shown in FIG. 10 to about four hundred packages. In some of these embodiments, elevator 540 is configured to stop at the various levels.

In some embodiments, raceway 580 and housing 510 are modular, permitting easy transport and installation. In some embodiments, this modular nature allows for the production of systems with different tradeoffs between package storage capacity and system footprint.

### Drone Landing Station

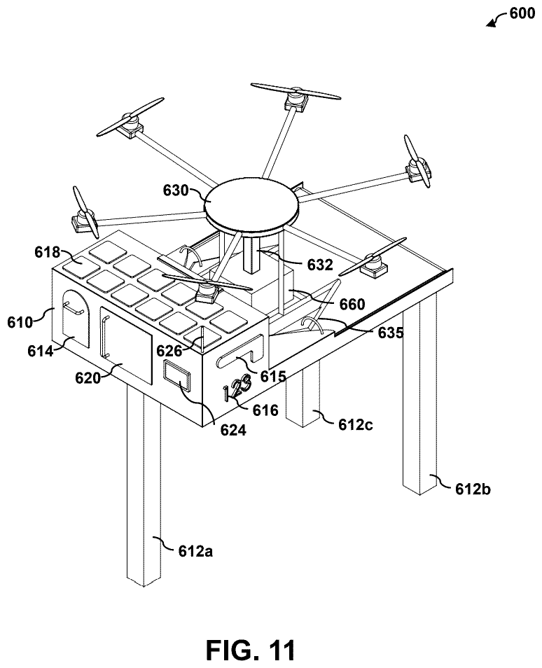

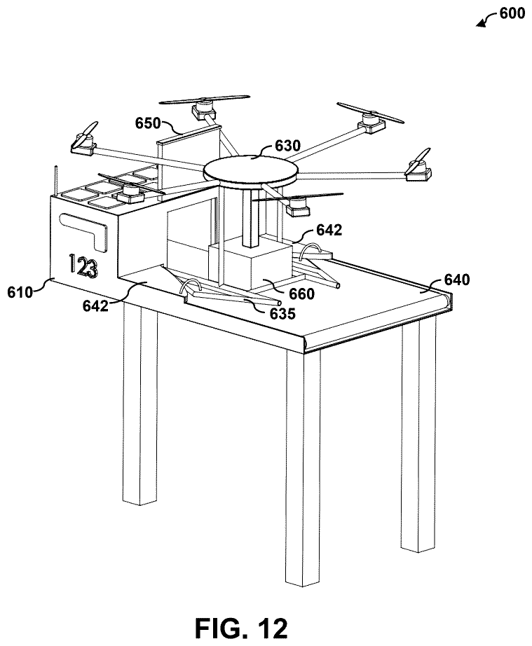

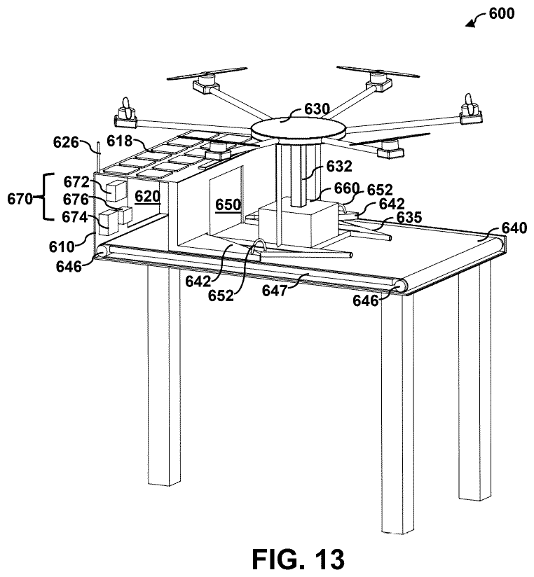

FIG. 11, FIG. 12, and FIG. 13 show an embodiment of drone delivery mailbox system 600. In some embodiments, drone delivery mailbox system 600 includes chassis 610 supported on leg 612a, leg 612b, and leg 612c. In some embodiments, leg 612a could be a standard 4″ (10.16 cm)×4″ (10.16 cm) post that has been retrofitted with drone delivery mailbox system 600. In some embodiments, postal door 614, outgoing mail flag 615 and/or street number label 616 allow drone delivery mailbox system 600 to replace a standard residential mailbox. In some embodiments, solar array 618 provides enough energy to charge internal batteries and operate drone delivery mailbox system 600.

In some embodiments, front parcel door 620 allows users to access the package storage volume within chassis 610. In some embodiments front parcel door 620 is controlled by an electronically activated latch. In some embodiments, user interface screen 624 allows system user to check status, control configuration and/or enter credentials to activate front parcel door 620. In some embodiments, wireless interface antenna 626 allows drone delivery mailbox system 600 to communicate with other elements of a drone delivery network and/or the cloud over cellular, wi-fi, satellite, or other interface types.

In some embodiments, drone 630 is a standard hexacopter design, with six motorized rotors, motor speed controllers, batteries and/or flight computers.

In some embodiments, cargo retention system 632 enables drone 630 to attach to package 660 or release it on command. In some embodiments, cargo retention system 632 uses magnets, hooks, squeeze bars, pins and/or other mechanisms to securely attach package 660 to drone 630. In some embodiments, hexagonal landing skid 635 supports drone 630 as it lands on system 600 and interacts with drone 630 to facilitate the unloading and loading of package(s) 660.

In some embodiments, such as shown in FIG. 12, conveyor belt 640 serves as a drone landing surface, and is capable of moving drone 630 and package 660 to facilitate storage of package 660 securely within chassis 610. In some embodiments, rear parcel door 650 is motorized to open upon a signal from a control system to admit package 660. In some embodiments, conveyor belt 640 passes under rear parcel door 650 and into the package storage volume within chassis 610. In some embodiments, bumpers 642 interact with hexagonal landing skid 635 as it is carried to the left by conveyor belt 640 to align drone 630 with the package aperture of rear parcel door 650. In some embodiments, as conveyor belt 640 moves to rear parcel door 650, the 120-degree angle defined by the left and right surfaces of hexagonal landing skid 635 interact with a similar angle defined by bumpers 642 to nudge drone 630 into a centered position in front of rear parcel door 650. In some embodiments, this reduces, if not eliminates, any yaw rotation of drone 630, making it square with rear parcel door 650. In at least some embodiments, this precise alignment in both translation and rotation aids in the reliable loading and unloading of packages.

In some embodiments, a friction control material/coating is applied to the underside of hexagonal landing skid 635 maintains the correct degree of friction between hexagonal landing skid 635 and conveyor belt 640 to facilitate the motions needed to align drone 630. In some embodiments, different regions of the underside of landing skid 635 use different friction control materials to provide the desired interactions with conveyor belt 640. Some examples of friction control material include, but are not limited to, polyethylene or polytetrafluoroethylene to reduce friction, fabrics, rough composites or sandpaper-like materials to increase it.

In some embodiments, such as shown in FIG. 13, conveyor belt 640 moves on guide rollers 646. In some embodiments, at least one of guide rollers 646. is motorized. In some embodiments, backing plate 647 supports the weight of drone 630, and prevents conveyor belt 640 from sagging. In some embodiments, backing plate 647 is made of, or coated with, a low friction material like, but not limited to, a polyethylene sheet or polytetrafluoroethylene.

In some embodiments, electronics assembly 670 consists of battery 672. In some embodiments, battery 672 is charged by solar array 618.

In some embodiments, control processor 674 executes instructions to operate drone delivery mailbox system 600. In some embodiments, control processor 674 communicates with external elements, drones and/or users. In some embodiments, interface module 676 adapts the signals used by control processor 674 to the needs of the motors in guide roller(s) 646. In some embodiments, interface module 676 adapts the signals used by control processor 674 to the needs of the actuator to raise and lower rear parcel door 650, the latch for front parcel door 620 and/or user interface screen 624. In some embodiments, interface module 676 provides a wireless transceiver function to drive antenna 626.

In some embodiments of operation of drone delivery mailbox system 600, drone 630 carries package 660 and lands on conveyor belt 640, near the center of its exposed area. In some embodiments, the precision landing can be facilitated by cameras and/or other sensors on the drone picking up the shape of drone delivery mailbox system 600, alignment markings printed on the conveyor belt 640, and/or using active systems like infrared tags. In some embodiments, drone 630 shuts down its rotors, and conveyor belt 640 moves drone 630 with package 660 from the landing portion of conveyor belt 640 towards the loading/unloading position near rear parcel door 650. Hexagonal landing skid 635 interacts with bumpers 642 to align drone 630 squarely and substantially centered in front of rear parcel door 650. In some embodiments, drone cargo retention system 632 is commanded to release package 660, and it drops a short distance onto conveyor belt 640. In some embodiments rear parcel door 650 opens, and conveyor belt 640 continues towards rear parcel door 650, pulling package 660 through the perimeter of landing skid 635 and into the package storage volume within chassis 610. In some embodiments, during this portion of the operation, package 660 is moving on conveyor belt 640, but drone 630 is being restrained by bumpers 642 and slides along moving conveyor belt 640 without moving. In some embodiments, the friction between the bottom of drone landing skid 635 and conveyor belt 640 is controlled to permit drone 630 to slide freely and not inhibit the motion of conveyor belt 640.

As discussed above, in some embodiments, alignment between drone 630 and rear parcel door 650 is achieved by using hexagonal landing skids 635 on the drone, and angled bumpers on the landing surface that interact with them to automatically align the drone within millimeters of its desired position by simply driving the conveyor belt towards the bumpers, which interact with the hexagonal geometry of the base of the drone to gather it toward the center of the belt, and align its yaw angle to be parallel with rear parcel door 650.

In some embodiments, after the package is received, rear parcel door 650 closes, and conveyor belt 640 moves away from rear parcel door 650 bringing drone 630 to a takeoff position so the rotors of drone 630 are clear of chassis 610. In some embodiments, this is near the center of the exposed portion of conveyor belt 640.

In some embodiments, package 660 is backstopped by the inner surface of closed rear parcel door 650 during this operation. In some embodiments, the friction between the bottom of package 660 and conveyor belt 640 is controlled to permit package 660 to slide freely within the cargo storage volume and not inhibit the motion of conveyor belt 640. In some embodiments, the control system then instructs the drone to depart.

In some embodiments, the package recipient is notified of the delivery, and comes to the front of drone delivery mailbox system 600. In some embodiments, the package recipient can either enter a PIN number on user interface screen 624 and/or use a mobile application to authenticate their identity, after which front parcel door 620 opens, allowing retrieval of package 660 and completing the delivery sequence.

In at least some embodiments, drone delivery mailbox system 600 is capable of sending packages. In some embodiments of operation of drone delivery mailbox system 600, a package sender approaches drone delivery mailbox system 600 and enters sending credentials either on user interface screen 624 and/or on a mobile application. In some embodiments, front parcel door 620 opens, the outgoing package is inserted, and front parcel door 620 is closed. In some embodiments, a drone is summoned by the control system using wireless antenna 626.

In some embodiments, empty drone 630 performs precision landing on conveyor belt 640 and shuts down. In some embodiments, conveyor belt 640 drives the drone towards rear parcel door 650, allowing hexagonal landing skid 635 to interact with bumpers 642 to align drone 630 squarely and substantially centered in front of rear parcel door 650. In at least some embodiments, bumpers 642 are stationary.

As discussed above, in some embodiments, alignment between drone 630 and rear parcel door 650 is achieved by using hexagonal landing skids 635 on the drone, and angled bumpers on the landing surface that interact with them to automatically align the drone within millimeters of its desired position by simply driving the conveyor belt.

In some embodiments, at least one docking clamp 652 engages features in hexagonal landing skid 635 to secure the drone with respect to rear parcel door 650. In some embodiments, rear parcel door 650 opens and conveyor belt 640 drives package 660 through it, through a gap in landing skids 635, and into the cargo loading position directly under drone 630. In some embodiments, drone cargo retention system 632 is commanded to attach package 660. In some embodiments, the drone is stationary, sliding on conveyor belt 640 during this segment of the operation because it is retained by docking clamps(s) 652 as the package and conveyer belt moves beneath it.

In some embodiments, at least one docking clamp 652 is conductive, enabling a charging circuit to be established between battery 672 and a battery on drone 630. In some embodiments, at least one docking clamp 652 has security features, preventing the unauthorized removal of drone 630 while it is engaged.

In some embodiments, once the package loading operation (and optional charging) are complete and verified by control processor 674, docking clamp(s) 652 is/are released and conveyor belt 640 moves away from rear parcel door 650 such that drone 630 and package 660 are put into a take-off position near the center of the exposed portion of conveyor belt 640. Drone 630 and package 660 can then depart completing the package send operation.

In some embodiments, conveyor 640 has an automatic clearing function. In employment, various debris, leaves, snow, and ice can accumulate on conveyor belt 640 inhibiting its function as a landing platform and causing difficulties with cargo storage operations. In some embodiments, when control processor 674 detects the possibility of such accumulation, it can drive empty conveyor belt 640 to the direction away from rear parcel door 650 over roller(s) 646, thus clearing any debris by dropping them on the ground below and making system 600 ready for its next package delivery or send operation. In some embodiments, this is done periodically regardless of whether or not the control processor detects anything. In some embodiments, conveyor belt 640 is sloped between one and five degrees up toward rear cargo door 650 so that moisture that falls on it drains away from the cargo storage volume within chassis 610. In some embodiments, weatherstripping is applied around the entire perimeter of front cargo door 620, rear cargo door 650 and/or under bumpers 642 to seal the inner volume of chassis 610 against moisture or debris.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or variants thereof, mean connection or coupling, either direct or indirect, permanent, or non-permanent, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function of the described component.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments. For example, the numbers of components in a system can be changed. Similarly, physical features of those components, including dimensions and weights may also change. The specifics disclosed above are not meant to be limiting.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A drone roost comprising:
an outer shell;
a top hatch to allow a drone to enter an interior of said drone roost;
a conveyor belt;
a drone storage wheel with an at least one drone storage shelf; and
a conveyor door.

2. The drone roost of claim 1 wherein said at least one drone storage shelf includes a package loading aperture.

3. The drone roost of claim 1 wherein said at least one drone storage shelf is configured to secure, recharge and/or program said drone.

4. The drone roost of claim 1 further comprising:
a cargo elevator.

5. The drone roost of claim 1 further comprising:
a solar panel.

6. The drone roost of claim 1, wherein said drone roost is configured to be mobile and includes at least one pair of wheels.

7. The drone roost of claim 1 further comprising a second drone storage wheel.

8. The drone roost of claim 1 further comprising a robotic system configured to recharge said drone.

9. The drone roost of claim 1 further comprising a robotic system configured to service said drone.

10. The drone roost of claim 1 wherein said drone storage wheel comprises:
a frame; and
a moving wheel frame.

11. The drone roost of claim 1 wherein said drone storage wheel further comprises:
a motor.

12. The drone roost of claim 5 wherein said drone storage wheel further comprises:
a motor.

13. The drone roost of claim 10 wherein said drone storage wheel further comprises:
a motor.

14. A drone roost comprising:
an outer shell;
a top hatch to allow a drone to enter an interior of said drone roost
a plurality of trays configured to move along an at least one guiderail; and
a charging system, wherein said charging system is powered via said at least one guiderail.

15. The drone roost of claim 14 further comprising:
a motor.

16. The drone roost of claim 14 further comprising:
a solar panel.

17. The drone roost of claim 14, wherein said drone roost is configured to be mobile and includes at least one pair of wheels.

18. The drone roost of claim 16 further comprising:
a motor.

19. The drone roost of claim 15, wherein said drone roost is configured to be mobile and includes at least one pair of wheels.

20. The drone roost of claim 16, wherein said drone roost is configured to be mobile and includes at least one pair of wheels.
